(19) United States
(12) Patent Application Publication
(10) Pub. No.: US 2013/0237153 A1
(43) Pub. Date: Sep. 12, 2013

(54) MOBILE DEVICE AND MANAGING METHOD THEREOF

(71) Applicant: PANTECH CO., LTD., Seoul (KR)

(72) Inventors: Nam Young RYU, Seoul (KR); Young Jin OH, Seoul (KR)

(73) Assignee: Pantech Co., Ltd., Seoul (KR)

(21) Appl. No.: 13/776,046

(22) Filed: Feb. 25, 2013

(30) Foreign Application Priority Data
Mar. 7, 2012 (KR) 10-2012-0023152

(51) Int. Cl. H04B 5/00

(52) U.S. Cl. CPC H04B 5/0043
USPC 455/41.1

(57) ABSTRACT

A mobile device and a method for managing the power consumption of the mobile device use geomagnetic sensors to determine if an external object is present. If an external object is approaching the mobile device, a near field communication unit is powered on and may communicate with the external object. Additional sensors may determine if the external object may be capable of NFC. Other components of the device may be powered on or off according to the presence of the external device.

### CROSS-REFERENCE TO RELATED APPLICATION

This application claims priority from and the benefit of Korean Patent Application No. 10-2012-0023152, filed on Mar. 7, 2012, which is incorporated by reference for all purposes as if fully set forth herein.

### BACKGROUND

1. Field

The following description relates to a mobile device and a method of managing the same and, more particularly, to a mobile device and method for reducing power consumption in a mobile device.

2. Discussion of the Background

With the rapid development of processor technologies, memory capacity, and multimedia encoding technologies, the features included in a mobile device, such as a smart phone or a smart pad, have been diversified. Various applications such as direction finding, an instant messenger service, and a scheduler may be executed on a mobile device and each application may use near field communication (NFC) hardware, such as Bluetooth or NFC included in a mobile device. Reducing power consumption of a mobile device increases the ability to implement various applications.

NFC hardware may be periodically executed by mobile devices in order to detect the approach of an external object capable of NFC. This may lead to unnecessary power consumption of a mobile device. Thus, time use efficiency of the mobile device may deteriorate and the mobile device may not be used for a long period of time.

### SUMMARY

Exemplary embodiments of the present invention provide a mobile device and a method for reducing power consumption in a mobile device by using a geomagnetic sensor.

Additional features of the invention will be set forth in the description which follows, and in part will be apparent from the description, or may be learned by practice of the invention.

An exemplary embodiment of the present invention discloses a mobile device, including: a geomagnetic sensor unit to detect a geomagnetic sensor value of a magnetic field near the mobile device; and a near field communication (NFC) unit to communicate with an external object, wherein the NFC unit is activated according to the geomagnetic sensor value.

An exemplary embodiment of the present invention also discloses a method for managing power in a mobile device including a near field communication unit, the method including: determining if a geomagnetic sensor value of a magnetic field near the mobile device is changed from a reference value; and activating a near field communication unit if the geomagnetic sensor value is changed.

An exemplary embodiment of the present invention also discloses a method for managing power consumption in a mobile device including a near field communication unit, the method including: determining if a geomagnetic sensor value of a magnetic field near the mobile device corresponds to a reference geomagnetic sensor value; determining if an additional sensor value has changed; and activating a near field communication (NFC) unit if the additional sensor value has changed.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a graph illustrating current as a function of time in a mobile device according to an exemplary embodiment of the present invention.

FIG. 2A is a diagram of a magnetic flux density near a geomagnetic sensor according to an exemplary embodiment of the present invention.

FIG. 2B is a diagram of a magnetic flux density near a geomagnetic sensor according to an exemplary embodiment of the present invention.

FIG. 3 is a diagram of a mobile device and a card according to an exemplary embodiment of the present disclosure.

FIG. 4 is a flowchart of a method for managing power consumption in a mobile device according to an exemplary embodiment of the present disclosure.

FIG. 5 is a diagram of a mobile device and a card according to an exemplary embodiment of the present disclosure.

FIG. 6 is a flowchart of a method for managing power consumption in a mobile device according to an exemplary embodiment of the present disclosure.

FIG. 7 is a diagram of a card and geomagnetic sensors according to an exemplary embodiment of the present invention.

FIG. 8 is a diagram of a difference between geomagnetic sensor values detected by a geomagnetic sensor of FIG. 4 according to an exemplary embodiment of the present disclosure.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Although features may be shown as separate, such features may be implemented together or individually. Further, although features may be illustrated in association with an exemplary embodiment, features for one or more exemplary embodiments may be combinable with features from one or more other exemplary embodiments

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Radio frequency identification (RFID) and near field communication (NFC) will be described.

RFID is an identification technique to wirelessly manage information about a variety of items such as food, animals, or items with an integrated circuit (IC) chip. RFID is a technique of including information about a process from beginning to end, such as from production to sale of a product, in an IC chip and tracking the information with a radio frequency and may be referred to as an “electronic tag,” a “smart tag,” an “electronic label,” or a “radio identification.” RFID is an identification technique which may replace the use of barcode for material management in a distribution field. RFID may include a reader to read and to decoding and a tag to provide information. Information about the process, such as, production, distribution, storage and consumption, may be contained in a tag attached to a product and may be read by the reader through an antenna. An information system may be used in association with a satellite or a mobile communication network. In a barcode storage capacity may be small, information in the bar code may not be checked in real time, and information in the bar code may be read at a close distance (e.g., within few cm). RFID may track the entire process, for example, from shipment of a product to exhibition of the product in a supermarket. If a consumer selects a product attached with an RFID tag, payment may be automatically performed and inventory control and consumer preference management are also performed automatically. An RF reader may read data of several hundreds of products attached with RF tags in one second. In a retail setting, for example, as soon as a consumer passes a counter, a total of price of products in the consumer's cart or basket may be computed if the products include RF tags and thus a checkout time may be reduced. RFID is different from a barcode in that information may be corrected or deleted in an RFID but may not be deleted or corrected in a barcode. RFID may be variously utilized. RFID may be used to detect if a product is stolen or duplicated and may be used to manage books in a library.

NFC is a non-contact communication technique which may be performed within a short distance. For example, a frequency of 13.56 MHz may be used for NFC and data may be transmitted between terminals within a distance of 10 cm from each other. NFC is a kind of RFID. In general RFID, identification may be possible using a reader regardless of an ON/OFF state of a terminal and reading of information may be possible. However, in NFC, data may be bidirectionally transmitted. RFID tag information may be identified in an NFC activation state. Since a mobile phone or a smart phone may operate as a card reader, both reading and writing may be possible. For example, if a smart phone having a transportation card is brought into proximity of a card reader, the smart phone may transmits information to the card reader and the card reader receives the information from the smart phone so as to perform payment. Payment, authentication, medical treatment, mobile advertisement, electronic ticket, electronic card, or micropayment may be performed based on NFC.

A mechanism for reading information from an external object (e.g., an IC card) including an NFC chip in mobile device is as follows. A mobile device including an NFC device may wirelessly transmit power to the external object through an antenna. The external object may activate the NFC chip using the power received from the mobile device. The external object may transmit memory information of the NFC chip to the mobile device. The mobile device may operate an application program using the received memory information of the NFC chip.

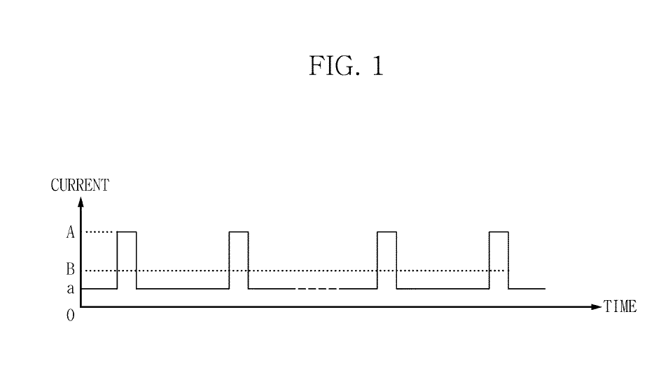

FIG. 1 is a graph illustrating current as a function of time in a mobile device according to an exemplary embodiment of the present invention.

Referring to FIG. 1, “a” may denote a current of the mobile device when the NFC device is not operational and “A” may denote a current of the mobile device when the NFC device operates. In other words, a difference between A and a, “A-a,” denotes a NFC driving current, and B denotes an average current of the mobile device. A general mobile device of the related art may not know if a card approaches the mobile device, and the general mobile device may periodically activate the NFC function in order to detect motion of the card. The average current of the general mobile device may increase from a to B and power may be wasted. In order to operate the NFC device, an application processor (AP) of the mobile device may be activated and additional power may be wasted. The exemplary embodiments may reduce the driving time of the NFC device and may thereby decrease the level of the average current B and reduce power consumption.

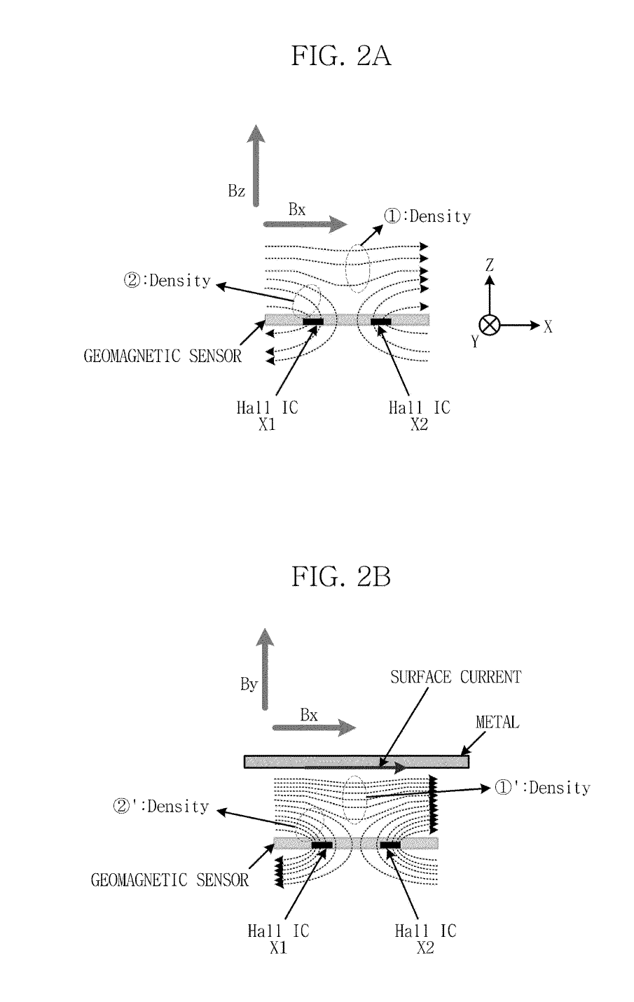

FIG. 2A is a diagram of a magnetic flux density near a geomagnetic sensor according to an exemplary embodiment of the present invention. FIG. 2B is a diagram of a magnetic flux density near a geomagnetic sensor according to an exemplary embodiment of the present invention.

A geomagnetic field is a region of Earth influenced by geomagnetism. Geomagnetism may be generated by the motion of the Earth's core relative to the mantle due to magnetism generated in Earth and Earth's surroundings. If observing geomagnetism, the following factors may be observed: 1) a difference angle (deflection angle) between north pointed to by a compass needle and Earth's true north, 2) an angle between an Earth's magnetic field direction and a horizontal plane thereof at any point of Earth and 3) a horizontal component (horizontal magnetic force) of the electromagnetic force of geomagnetism. Referring to FIG. 2A, a geomagnetic sensor may detect a magnetic field or a magnetic flux density around a geomagnetic sensor and may include Hall integrated circuit (IC) X1 and Hall IC X2. If an external object is not present near a geomagnetic sensor, the geomagnetic sensor may detect the geomagnetic field of the Earth. However, as illustrated in FIG. 2B, the magnetic flux density surrounding the geomagnetic sensor may change if an external object is present, for example, a metal external object, and the change in the magnetic flux density may be detected. The changed magnetic flux density may be a vector sum of the Earth's geomagnetic field and the magnetic flux density added by the external object. If the external object is an IC card and a surface current is generated by supplying power through a peripheral device to the IC card, a magnetic density value detected by the geomagnetic sensor my change due to a magnetic field induced around the IC card. An activation time of an NFC device may be reduced by using a difference in magnetic flux density detected by a geomagnetic sensor to determine if to activate the NFC device. The magnetic flux density value may be changed according to the position of the geometric sensor, if geomagnetic sensors are separated from each other by a reference distance are present in the mobile device, different geomagnetic sensor values may be measured.

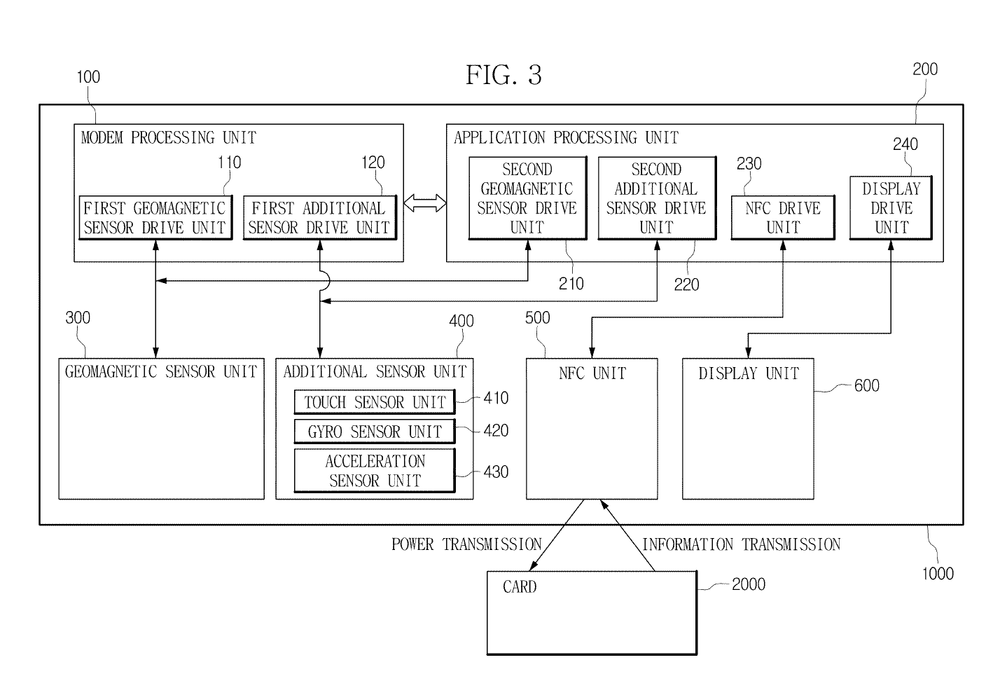

FIG. 3 is a diagram of a mobile device and a card according to an exemplary embodiment of the present disclosure. A mobile device 1000 may include a modem processing unit 100, an application processing unit 200, a geomagnetic sensor unit 300, an additional sensor unit 400, a near field communication (NFC) unit 500, and a display unit 600. A card 2000 is shown as an example of an external object.

The mobile device 1000 may be variously implemented and may include various features. The mobile device 1000 may be any devices to execute a reference application. An application, i.e., an arbitrary program, may be executed via the mobile device 1000 and may use, for example, a camera unit, a memory unit, and computation unit of the electronic content display apparatus. For example, the mobile device 1000 may include a handheld wireless terminal, such as, a Personal Communication System (PCS) terminal, a Global System for Mobile communications (GSM) terminal, a Personal Digital Cellular (PDC) terminal, a Personal Handyphone System (PHS) terminal, a Personal Digital Assistant (PDA), and an International Mobile Telecommunication (IMT)-2000 terminal. The mobile device 1000 may be a smart phone or a smart pad including a display, various sensors, such as, a touch sensor, a vibration motor, a speaker, a communication module, etc. The mobile device 1000 may include a processing system which includes a processor, an operating system (OS), and an application program interface (API). The processing system may provide communication between one or more software applications and the OS. The processing system of the mobile device 1000 may be configured to execute various software applications.

The mobile device 1000 may communicate with another object and may include communication hardware or software. A communication method of the mobile device 1000 may include any communication method for networking between objects, such as wired/wireless communication, 3G, 4G, etc. All transmittable information and receivable information may include a variety of sensor information, voice feedback information, and vibration feedback information of the mobile device 1000 and may be transmitted to an external object or received by an internal component, respectively. A communication method may be performed using one or more communication methods selected from a group consisting of wireless Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee®, Wi-Fi®, Voice over Internet Protocol (VoIP), 3GPP Long Term Evolution (LTE), LTE Advanced, IEEE802.16m, WirelessMAN-Advanced, HSPA+, Mobile WiMAX (IEEE 802.16e), UMB (formerly EV-DO Rev. C), Flash-Orthogonal Frequency-Division Multiplexing Flash-OFDM, iBurst and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX), but is not limited to.

The operating system (OS) of the mobile device 1000 may be selected from one of the operating system Android from Google Inc., Blackberry® OS from RIM Inc., iOS from Apple Inc., Symbian® OS from Nokia Inc., Windows Mobile from Microsoft Corporation, and Bada from Samsung Electronics, but are not limited thereto.

The modem processing unit 100 may process radio communication data. Radio communication data may be transmitted using a communication scheme such as WCDMA or LTE. The modem processing unit 100 may activate a first geomagnetic sensor drive unit 110. The geomagnetic sensor unit 300 may be controlled by a second geomagnetic sensor drive unit 210 of the application processing unit 200 or may be controlled by the first geomagnetic sensor drive unit 110. If the modem processing unit 100 manages the geomagnetic sensor unit 300, current consumption may be reduced compared with the case in which the application processing unit 200 manages the geomagnetic sensor unit 300. The modem processing unit 100 may manage the geomagnetic sensor unit 300 to improve power efficiency.

The modem processing unit 100 may include a modem processor (not shown). The modem processor unit 100 may include the first geomagnetic sensor drive unit 110 and a first additional sensor drive unit 120.

The first geomagnetic sensor driver unit 110 may determine whether a geomagnetic sensor value A detected by the geomagnetic sensor unit 300 corresponds to a reference geomagnetic value A′ or pre-determined or set value or range. The first geomagnetic sensor drive unit 110 may determine whether the geomagnetic sensor value A detected by the geomagnetic sensor unit 300 is substantially similar to the reference geomagnetic value A′. In addition the first geomagnetic sensor drive unit 110 may determine whether the geomagnetic sensor value A detected by the geomagnetic sensor unit 300 is greater than or less than the reference geomagnetic value A′ and/or the pre-determined or set value. The reference geomagnetic value A′ may be the value detected by the geomagnetic sensor unit 300 if an external object (e.g., the card 2000) is not present, as illustrated in FIG. 2A. The reference geomagnetic value A′ may be stored in the first geomagnetic sensor drive unit 110 or a separate memory (not shown). If the geomagnetic sensor value A is substantially similar to the reference geomagnetic value A′, it does not indicate that the geomagnetic sensor value A is equal to the reference geomagnetic value A′. Because errors may be generated, the geomagnetic sensor value A may be substantially similar to the reference geomagnetic value if a difference between the geomagnetic sensor value A and the reference geomagnetic value A′ does not exceed a reference error threshold. The first geomagnetic sensor drive unit 110 may be a geomagnetic sensor driver.

The first additional sensor drive unit 120 may determine if the external object may perform NFC with the mobile device 1000 based on an additional sensor value detected by the additional sensor unit 400, if it is determined that the detected geomagnetic sensor value A corresponds to the reference geomagnetic value A′ in the first geomagnetic sensor drive unit 110. The first additional sensor drive unit 120 may supplement the geomagnetic sensing of the first geomagnetic sensor drive unit 110. If it is determined that the external object may perform NFC with the mobile device 1000, the application processing unit 200 may be activated. A determination as to whether the card 2000 may perform communication with the mobile device 1000 may be made through a touch sensor value of a touch sensor unit 410 in a state in which the external object, i.e., the card 2000, approaches the mobile device 1000. The determination may be made in the state in which the external object is approaching the mobile device because a user's hand may touch the mobile device 1000 while performing NFC. Because a three-dimensional angle of the mobile device 1000 may be changed by a user's touch, a stochastically high change value in three-dimensional angle may be compared with a reference gyro value to determine whether the card 2000 may perform communication with the mobile device 1000. A speed at which the mobile device 1000 is moving may be changed by a user, and thus a stochastically high change value in speed may be compared with a reference acceleration value to determine whether the card 2000 may perform communication with the mobile device 1000. The first additional sensor drive unit 120 may include a touch sensor driver, a gyro sensor driver, and an acceleration sensor driver.

The application processing unit 200 may manage execution of an application program in the mobile device 1000. The application processing unit 200 may perform computation to execute the application program. The application processing unit 200 may include an application processor. The application processing unit 200 may include a second geomagnetic sensor drive unit 210, a second additional sensor drive unit 220, a NFC drive unit 230, and a display drive unit 240. The application processing unit 200 may further include a component to execute the application program. The application processing unit 200 may activate a NFC unit 500.

The second geomagnetic sensor drive unit 210 may manage the geomagnetic sensor unit 300 to execute the application program using the geomagnetic sensor unit 300. The second geomagnetic sensor drive unit 210 may drive the geomagnetic sensor unit 300 to execute the application program using the geomagnetic sensor unit 300, e.g., a compass application, a map application, a direction-finding or navigation application, etc. The first geomagnetic sensor drive unit 110 of the modem processing unit 100 may drive the geomagnetic sensor unit 300 to detect the approach of the external object. The second geomagnetic sensor drive unit 210 may include a geomagnetic sensor driver.

The second additional sensor drive unit 220 may manage the geomagnetic sensor unit 300 in order to execute the application program using the additional sensor unit 400. The additional sensor unit 400 may include a touch sensor unit 410, a gyro sensor unit 420, an acceleration sensor unit 430, etc. The second additional sensor drive unit 220 may drive the additional sensor unit 400 to execute the application program, e.g., a photo application, an augmented reality application, a game application, etc. using at least one of the touch sensor unit 410, the gyro sensor unit 420, and the acceleration sensor unit 430 included in the additional sensor unit 400. The first additional sensor drive unit 120 of the modem processing unit 100 may drive the additional sensor unit 400 to detect the approach of the external object. The second additional sensor drive unit 220 may include a touch sensor driver, a gyro sensor driver, and an acceleration sensor driver.

The NFC drive unit 230 may manage the NFC unit 500 to execute the application program. An application, such as, payment, authentication, mobile advertisement, electronic ticket, electronic card, etc., may be executed by the NFC unit 500. The NFC drive unit 230 may activate the NFC unit 500. The NFC drive unit 230 may activate the NFC unit 500 such that the operation time of the NFC unit 500 is reduced.

The display drive unit 240 may manage the operation of the display unit 600. The display drive unit 240 may activate the display unit 600 such that a user may check a user interface of an application program which is being executed by the mobile device 1000.

The geomagnetic sensor unit 300 may measure an external magnetic field of the mobile device 1000. The geomagnetic sensor unit 300 may include a sensor and/or a processor and may include may include one or more Hall integrated circuits. The geomagnetic field may be the Earth's geomagnetic field. The geomagnetic sensor unit 300 may detect a magnetic field around the geomagnetic sensor, i.e., magnetic flux density, and may detect a the Earth's geomagnetic field if an external object is not present near the mobile device 1000. However, as illustrated in FIG. 2B, if the magnetic flux density is changed by an external object, the changed magnetic flux density may be detected by the geomagnetic sensor unit 300. The changed magnetic flux density may be a vector sum of the Earth's geomagnetic field and the magnetic flux density added by the external object. If the external object is an IC card and surface current is generated in the IC card, for example, by supplying power through a peripheral device to the IC card, a magnetic density value detected by the geomagnetic sensor may change due to a magnetic field induced around the IC card.

The additional sensor unit 400 may include various sensors. The additional sensor unit 400 may include the touch sensor unit 410, the gyro sensor unit 420, and the acceleration sensor unit 430. The touch sensor unit 410 may detect a touch on the mobile device 1000, the gyro sensor unit 420 may detect three-dimensional motion of the mobile device, and the acceleration sensor unit 430 may detect movement of the mobile device 1000.

The NFC unit 500 may perform NFC between the mobile device 1000 and a terminal in a short distance. The NFC unit 500 may include an NFC device or an RFID device. The mobile device 1000 including the NFC unit 500 may wirelessly transmit power to the external object through an antenna. For example, power may be transmitted to the card 2000. The external object (e.g., card 2000) may activate an NFC chip using the power received from the mobile device 1000. The NFC unit 500 may receive memory information of the NFC chip of the external object. The application processing unit 200 may use the memory information received through the NFC unit 500 to execute the application program, such as, payment, authentication, mobile advertisement, electronic ticket, electronic card, etc.

The display unit 600 may display a variety of screens on the mobile device 1000. The display unit 600 may be any display unit including, for example, a light emitting diode (LED), an organic light emitting display (OLED), a light emitting polymer (LEP), an electro-luminescent (EL) element, a field emission display (FED), or a polymer light emitting display (PLED), etc. The display unit 600 may be activated to execute the application program. The application program may be executed by the NFC drive unit 230 using the memory information of the external object received through the NFC unit 500.

The card 2000 may be an external object of the mobile device 1000 and may be a representative object which may perform NFC. The external object may be any object to perform NFC and may include an NFC chip and/or an RFID chip, and is not limited to the card 2000 described above. The card 2000 may include an antenna made of metal (copper) to transmit data.

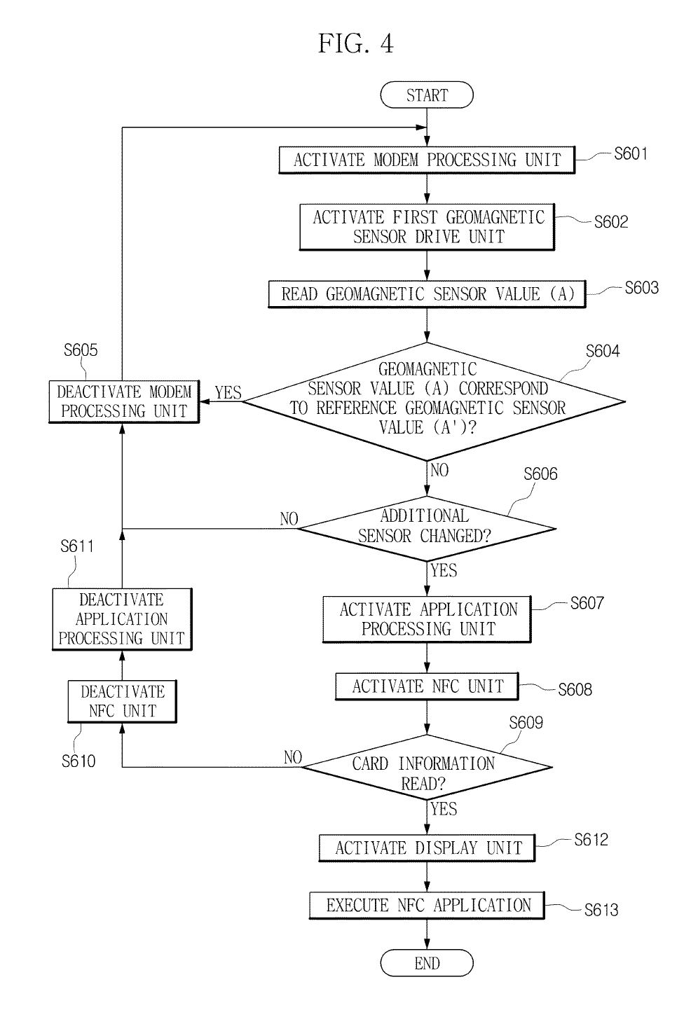

FIG. 4 is a flowchart of a method for managing power consumption in a mobile device according to an exemplary embodiment of the present disclosure. Although described with reference to FIG. 3, the method of FIG. 4 is not limited thereto.

In operation S601, the modem processing unit 100 is activated. In operation S602, the first geomagnetic sensor drive unit 110 is activated by the modem processing unit 100. In operation S603, the first geomagnetic sensor drive unit 110 manages the geomagnetic sensor unit 300 to read a sensor value A. In operation S604, it is determined whether the geomagnetic sensor value A read by the geomagnetic sensor unit 300 corresponds to a reference geomagnetic value A′. If geomagnetic sensor value A corresponds to reference value A′, in operation S605, the modem processing unit 100 is deactivated. If a reference time has elapsed, the modem processing unit 100 may be activated again and the method returns to operation S601. A time that elapses between deactivation and activation of the modem processing unit may be referred to as an activation period of the modem processing unit 100. If an external object does not approach the mobile device, this activation period may be repeated and/or extended. If the geomagnetic sensor value A does not correspond to the reference geomagnetic value A′, in operation S606, it is determined if the additional sensor unit 400 detect a change in parameters being sensed. The additional sensor unit 400 may include at least one of a touch sensor unit 410, a gyro sensor unit 420, an acceleration sensor unit 430, etc. If a change is detected by the additional sensor unit 400, in operation 607, the application processing unit 200 is activated. The additional sensor unit 400 may detect, for example, a touch on the mobile device 1000, a change in a reference three-dimensional motion of the mobile device 1000, a reference movement the mobile device 1000, or a speed of the mobile device 1000. If a change is not detected in the additional sensor unit 400 in operation S606, the method proceeds to operation S605 and the modem processing unit 100 is deactivated. If a user's hand does not approach the mobile device, it may be determined if a card or a metal material approaches the mobile device. If the speed of the external object is more important than detection accuracy of the external object, operation S606 may be skipped. In operation S608, the application processing unit 200 activates the NFC unit 500. In operation S609, the application processing unit 200 determines if card information is read from the external object, e.g., the card. The card information of the external object may be read by transmitting power to the external object through the NFC unit 500 and by receiving memory information from the external object. If the card information of the external object is not read, an error may be determined, and, in operation S610, the NFC unit 500 is deactivated and the method proceeds to operation S611 and operation S605, sequentially. If the information of the card is successfully read, in operation S612, the display unit may be activated. In operation S613, the application program to perform NFC is executed. The NFC unit 500 may be activated if the geomagnetic sensor unit 300 operates. Thus, the activation time of the NFC unit 500 may be reduced.

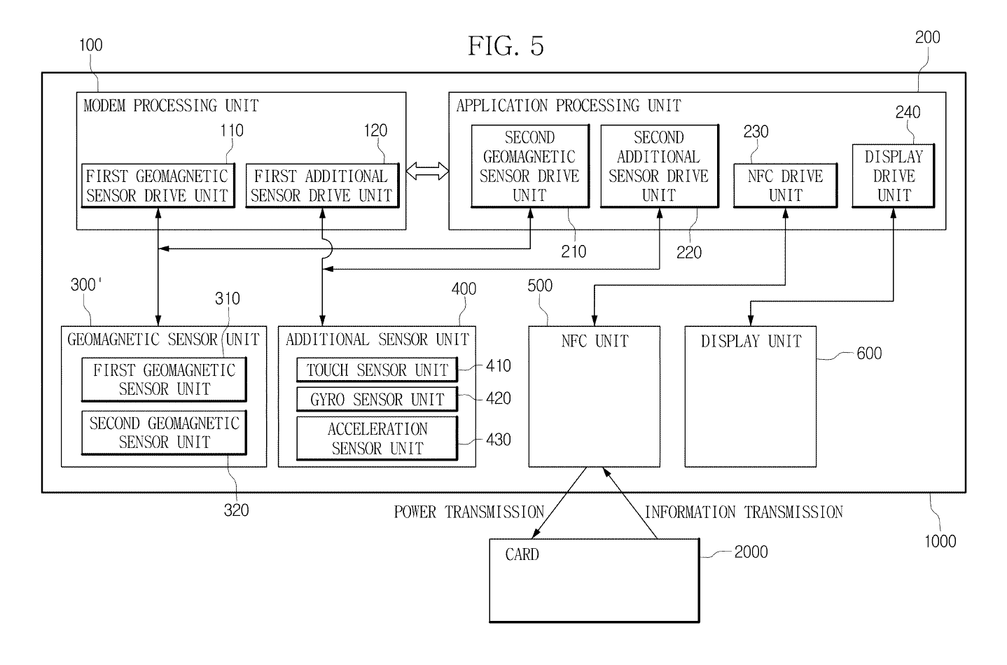

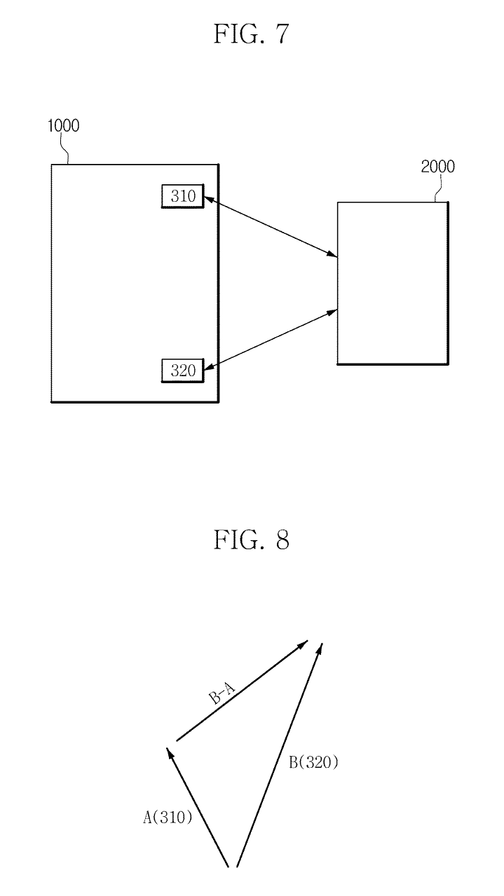

FIG. 5 is a diagram a mobile device and a card according to an exemplary embodiment of the present invention. The mobile device 1000 of FIG. 5 may be substantially similar to the mobile device 1000 of FIG. 3, and descriptions of similar features may be omitted for brevity. FIG. 7 is a diagram of a card and geomagnetic sensors according to an exemplary embodiment of the present invention. FIG. 8 is a diagram of a difference between geomagnetic sensor values detected by a geomagnetic sensor of FIG. 4 according to an exemplary embodiment of the present disclosure.

FIG. 5 may differ from FIG. 3 in that the geomagnetic sensor unit 300′ may include a first geomagnetic sensor unit 310 and a second geomagnetic sensor unit 320. The first geomagnetic sensor unit 310 and the second geomagnetic sensor unit 320 may be separated from each other by a reference distance as illustrated in FIG. 7. The first geomagnetic sensor unit 310 and the second geomagnetic sensor unit 320 may detect a change in magnetic field, i.e., magnetic flex density, according to a distance to the external object and to the type of the external object. If the external object approaches the mobile device 1000, the first geomagnetic sensor unit 310 and the second geomagnetic sensor unit 320 may detect different sensor values. If a difference between the sensor values of the first geomagnetic sensor unit 310 and the second geomagnetic sensor unit 320 is substantially similar to a reference difference value, it may be determined that the external object is approaching the mobile device. The first geomagnetic sensor unit 310 may be disposed adjacent to the NFC unit 500 and the second geomagnetic sensor unit 320 may be disposed to be separated from the NFC unit 500 by the largest distance possible. The second geomagnetic sensor unit 320 may be less influenced by the card 2000 than the first geomagnetic sensor unit 310.

The first geomagnetic sensor drive unit 110 may determine whether the first geomagnetic sensor value detected by the first geomagnetic sensor unit 310 corresponds to the second geomagnetic sensor value detected by the second geomagnetic sensor unit 320. As illustrated in FIG. 7, the first geomagnetic sensor unit 310 and the second geomagnetic sensor unit 320 may be separated from each other by a reference distance and/or may be disposed at opposite ends or sides of the mobile device 1000. If an external object is not present, the first geomagnetic sensor unit 310 and the second geomagnetic sensor unit 320 may measure the same geomagnetic field and may detect the same geomagnetic sensor value. However, if an external object (e.g., the card 2000) is present, the induced magnetic field may be change, i.e., magnetic flux density may change, according to the type of the external object and the distance between the external object and each of the first geomagnetic sensor unit 310 and the second geomagnetic sensor unit 320. The distance between the card 2000 and each of the first geomagnetic sensor unit 310 and the second geomagnetic sensor unit 320 may differ and thus the first geomagnetic sensor unit 310 and the second geomagnetic sensor unit 320 may detect different sensor values. As illustrated in FIG. 8, if the first geomagnetic sensor unit 310 detects a magnetic field vector A and the second geomagnetic sensor unit 320 detects a magnetic field vector B, a difference between the magnetic field vectors is magnetic field vector B-A. The difference (magnetic field vector B-A of FIG. 8) between the sensor values of the first geomagnetic sensor unit 310 and the second geomagnetic sensor unit 320 may differ according to the distance to the card 2000 and the kind of material used in the card 2000. The difference between the magnetic field vectors as an object approaches the mobile device may be determined experientially and may be stored in the mobile device 1000. If the difference between the geomagnetic sensor values of the first geomagnetic sensor unit 310 and the second geomagnetic sensor unit 320 corresponds to the reference difference value, it may be determined that the external object is approaching the mobile device.

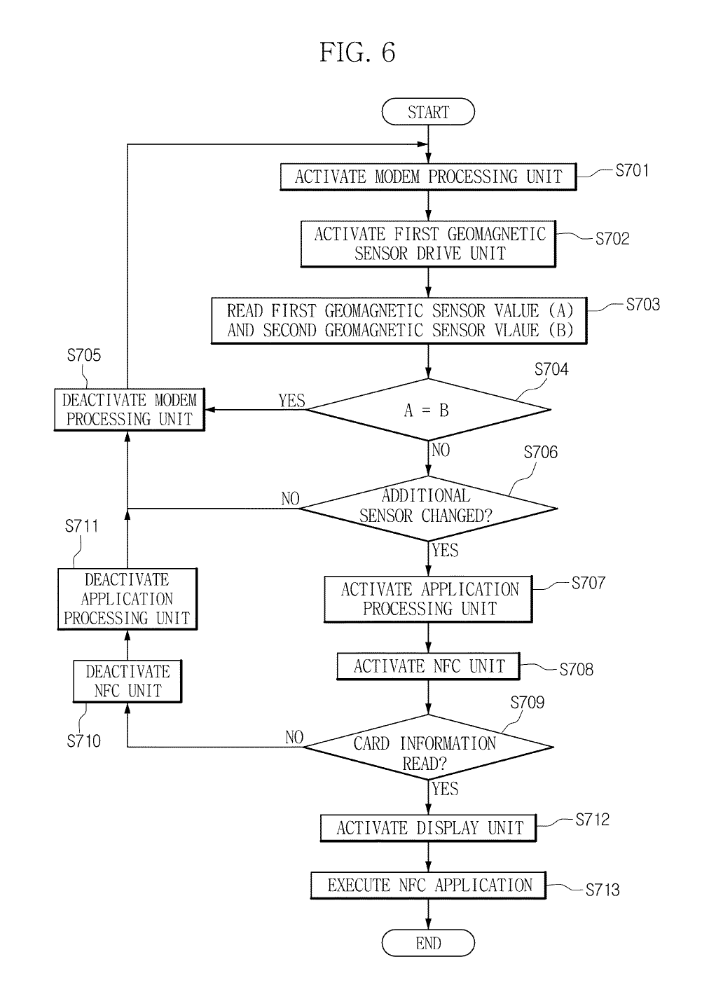

FIG. 6 is a flowchart of a method for managing power consumption in a mobile device according to an exemplary embodiment of the present disclosure. Although described with reference to FIG. 5, the method of FIG. 6 is not limited thereto.

FIG. 6 differs from FIG. 4 in that two geomagnetic sensor units are used in the method of FIG. 6. As such, the operations of FIG. 6 may be substantially similar to the operations of FIG. 4 except in operation S703 and operation S704. In operation S701, the modem processing unit 100 is activated. In operation S702, the first geomagnetic sensor drive unit 110 is activated by the modem processing unit 100. In operation S703, the sensor value A of the first geomagnetic sensor unit 310 and the sensor value B of the second geomagnetic sensor unit 320 are read by the first geomagnetic sensor unit 110. Since the first geomagnetic sensor unit 310 and the second geomagnetic sensor unit 320 are physically separated from each other by a reference distance, if the external object, e.g., the card 2000, approaches the mobile device, the distance between the first geomagnetic sensor unit 310 and the external object and the distance between the second geomagnetic sensor unit 320 and the external object are different. The geomagnetic sensor value A of the first geomagnetic sensor unit 310 and the geomagnetic sensor value B of the second geomagnetic sensor unit 320 may be different if the card 2000 approaches the mobile device 1000. In operation S704, it is determined if the first geomagnetic sensor value A is substantially similar to the second geomagnetic sensor value B. If the first geomagnetic sensor value A is substantially similar to the second geomagnetic sensor value B, in operation S705, the modem processing unit 100 is deactivated. If the first geomagnetic sensor value A does not correspond to the second geomagnetic sensor value B, in operation S706, it is determined if the additional sensor unit 400 detect a change in parameters being sensed. If the difference between the geomagnetic sensor values correspond to a reference difference value determined according to the kind and distance of the external object, i.e., only if A and B are different, in operation S707, the NFC unit may be activated. The additional sensor unit 400 may detect, for example, a touch on the mobile device 1000, a change in a reference three-dimensional motion of the mobile device 1000, a reference movement the mobile device 1000, or a speed of the mobile device 1000. If a change is not detected in the additional sensor unit 400, in operation S706, the method proceeds to operation S705 and the modem processing unit 100 is deactivated. If a user's hand does not approach the mobile device, it may be determined if a card or a metal material approaches the mobile device. If the speed of the external object is more important than detection accuracy of the external object, operation S706 may be skipped. In operation S708, the application processing unit 200 activates the NFC unit 500. In operation S709, the application processing unit 200 determines if card information is read from the external object, e.g., the card. The card information of the external object may be read by transmitting power to the external object through the NFC 500 and by receiving memory information from the external object. If the card information of the external object is not read, an error may be determined, and, in operation S710, the NFC unit 500 is deactivated and the method proceeds to operation S711 and operation S705, sequentially. If the information of the card is successfully read, in operation S712, the display unit may be activated. In operation S713, the application program to perform NFC is executed. The NFC unit 500 may be activated if the geomagnetic sensor unit 300 operates. Thus, the activation time of the NFC unit 500 may be reduced.

According to the exemplary embodiments, it is possible to reduce power usage due to NFC hardware.

It may be possible to execute NFC hardware of a mobile device with reduced power consumption, by enabling a modem processing unit to manage a geomagnetic sensor.

Furthermore, it may be possible to reduce malfunctions of NFC hardware by checking malfunction through another sensor and to reduce power which may be generated due to a malfunction. It may be possible to reduce power loss in a sleep mode of a mobile device.

Because the use time of a mobile device may increase with the same power, it may be possible to use a mobile device for a longer time by charging the mobile device once.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile device, comprising:
a geomagnetic sensor unit to detect a geomagnetic sensor value of a magnetic field near the mobile device; and
a communication unit to communicate with an external object,
wherein the communication unit is activated according to the geomagnetic sensor value.

2. The mobile device of claim 1, further comprising:
a modem processing unit to determine if an external object approaches mobile device according to the geomagnetic sensor value and to activate the communication unit if the external object approaches the mobile device.

3. The mobile device of claim 1, wherein, if the communication unit is activated, the communication unit transmits power to the external object.

4. The mobile device of claim 1, further comprising:
an application processing unit to execute an application according to the geomagnetic sensor value.

5. The mobile device of claim 1, further comprising:
an additional sensor unit to measure an additional sensor value,
wherein the communication unit is activated if the additional sensor value changes.

6. The mobile device of claim 5, wherein the additional sensor unit comprises at least one of a touch sensor unit, a gyro sensor unit, and an acceleration sensor unit.

7. The mobile device of claim 2, wherein the modem processing unit comprises:
a first geomagnetic sensor drive unit to determine if the external object approaches mobile device if the geomagnetic sensor value is equal to a reference geomagnetic sensor value; and
a first additional sensor drive unit to determine if the communication unit is capable of communicating with the external object according to a change in an additional sensor value.

8. The mobile device of claim 1, wherein the geomagnetic sensor unit comprises:
a first geomagnetic sensor unit to detect a first geomagnetic sensor value,
a second geomagnetic sensor unit to detect a second geomagnetic sensor value, and
wherein the communication unit is activated if the first geomagnetic sensor value does not equal the second geomagnetic sensor value.

9. The mobile device of claim 1, wherein the communication unit is at least one of a near field communication unit and a radio frequency identification unit.

10. A method for managing power consumption in a mobile device including a near field communication unit, the method comprising:
determining if a geomagnetic sensor value of a magnetic field near the mobile device is changed from a reference value; and
activating a communication unit if the geomagnetic sensor value is changed.

11. The method of claim 10, wherein the communication unit is at least one of a near field communication unit and a radio frequency identification unit.

12. A method for managing power consumption in a mobile device including a communication unit, the method comprising:
determining if a geomagnetic sensor value of a magnetic field near the mobile device corresponds to a reference geomagnetic sensor value;
determining if an additional sensor value has changed; and
activating the communication unit if the additional sensor value has changed.

13. The method of claim 12, wherein the communication unit is at least one of a near field communication unit and a radio frequency identification unit.

14. The method of claim 12, further comprising:
activating an application processing unit to execute applications if the additional sensor value has changed.

15. The method of claim 12, further comprising:
activating a display unit if the communication unit is activated.

16. The method of claim 12, wherein the additional sensor value may be at least one of a value of a touch sensor unit, a gyro sensor unit, and an acceleration sensor unit.

17. The method of claim 12, further comprising:
if the communication unit is activated, sending a power transmission to an external object.

18. The method of claim 17, further comprising:
determining if data is received from the external object;
deactivating the communication unit if data is not received from the external object; and
activating a display unit if data is received from the external object and executing a communication application according to the data.

19. The method of claim 12, wherein determining if a geomagnetic sensor value of a magnetic field near the mobile device corresponds to a reference geomagnetic sensor value comprises:
determining a first geomagnetic sensor value;
determining a second geomagnetic sensor value; and
determining if the first geomagnetic sensor value does not correspond to the second geomagnetic sensor value.
